(19) United States
(12) Patent Application Publication
(10) Pub. No.: US 2009/0167800 A1
(43) Pub. Date: Jul. 2, 2009

(54) INKJET RECORDING APPARATUS, IMAGE FORMING SYSTEM, AND COMPUTER-READABLE ENCODING MEDIUM RECORDED WITH A COMPUTER PROGRAM THEREOF

(76) Inventors: Shinichi HATANAKA, Kanagawa (JP); Masakazu Yoshida, Kanagawa (JP); Masanori Hirano, Kanagawa (JP); Takashi Kimura, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/343,953

(22) Filed: Dec. 24, 2008

(30) Foreign Application Priority Data
Dec. 27, 2007 (JP) NO. 2007-337176
Oct. 20, 2008 (JP) NO. 2008-269811

(51) Int. Cl. B41J 29/38

(52) U.S. Cl. 347/14

(57) ABSTRACT

An inkjet recording apparatus is disclosed, including: a jaggy correction process part for recording a dot for the jaggy correction at a border portion of an image. A droplet amount of each of color inks forming the dot for the jaggy correction using the color inks is selectively determined to be less than a droplet amount of an ink forming a dot for the jaggy correction using the black color.

### BACKGROUND OF THE INVENTION

1. Field of the Invention

The present invention generally relates to an inkjet recording apparatus, an image forming system, and a computer-readable encoding medium recorded with a computer program thereof, and more particularly to the inkjet recording apparatus, the image forming system, and the computer-readable encoding medium recorded with a computer program thereof, which improve a quality of recording an image and a letter.

2. Description of the Related Art

Conventionally, technologies are presented to form a letter and an image by an inkjet recording method. Since an inkjet recording apparatus realizes a high quality of recording an image and is relatively a low cost, the inkjet recording apparatus has been widely used as an output device of a personal computer.

An inkjet recording head, which is a part of the inkjet recording apparatus, is controlled to move in a main scan direction which is orthogonal to a direction of conveying a recording sheet, and includes a plurality of nozzles in a sub scan direction which is the direction conveying the recording sheet.

Each nozzle discharges ink droplets at a timing corresponding to dot pattern data which are acquired by developing record data, and the ink droplets from each nozzle are adhered to a recording medium such as a paper sheet, so that the dot pattern data are printed on the recording medium.

The inkjet recording apparatus is further desired to perform at higher speed, realize a higher image quality, a minimized size, and lower expense. The higher speed can be realized by setting an ink jet driving frequency higher, increasing a number of nozzles for jetting an ink, conducting a print of a lower resolution in a case in that a print resolution is higher than a resolution of nozzles, or a like. Also, the higher image quality can be realized by micronizing a dot size, conducting a high resolution print, or a like.

As described above, since the higher speed and the higher image quality are conflicting characteristics, it is difficult to realize the two conflicting characteristics at the same time. In practice, it attempts to overcome this difficulty by increasing the number of nozzles and printing with minimized dots.

However, if the number of nozzles is increased, a size of a recording head inevitably becomes bigger and the recording head becomes expensive. Disadvantageously in a practical stage, the bigger size of the recording head leads a size of the entire inkjet recording apparatus to become bigger, increase vibration and noise when the recording head moves, and increase power consumption.

Accordingly, in order to highly improve the speed and the image quality without increasing the number of nozzles, technologies are presented by methods for visually improve a resolution by modifying an arrangement of nozzles as described in Japanese Laid-open Patent Applications No. 2-02675 and No. 2001-171153, and Japanese Patent No. 3533771.

In these technologies, nozzles for three elementary colors (Magenta, Cyan, and Yellow) are arranged on the same scan line in which a pitch of a black ink nozzle is displaced by ½. When recording monochrome data, it is printed by using a black color of a black ink in combination with a process black color depicted by mixing color inks. Thus, it can be realized to a double resolution for a color print, instead of decreasing a record speed.

Also, as one of embodiments of the inkjet recording apparatuses, a line head fixed to a body of the inkjet recording apparatus is well known in that the inkjet recording head is formed in a length of an approximately maximum photographic printing width.

According to the inkjet recording apparatus of a line head type, the recording head is not required to move in the main scan directions, and a image is formed by simply conveying a recording medium in the sub scan direction orthogonal to the main scan direction. Thus, it is advantageous for forming an image at higher speed.

In the inkjet recording apparatus of the line head type, as described above, nozzles of the three primary colors (Magenta, Cyan, and Yellow) are arranged on the same scan line in which the pitch of the black inkjet nozzle is displaced by ½ and jet the process black color by mixing the three primary colors. Accordingly, instead of reducing the record speed, it is realized to perform a print for the monochrome data with a twice resolution as good as a color print.

Since an image is depicted by dots which are formed by a inkjet printer in a matrix shape in a scan direction of the recording head and a direction which is orthogonal to the scan direction and is of conveying the recording sheet, a hatched portion of a letter is advantageously acknowledged as a jagged edge.

In order to overcome the above problem, as described in Japanese Laid-open Patent Application No. 2007-145022, another technology is presented as an image output method which reduces a jagged edge of an image. In the image output method, dots are additionally printed to a border portion and dots of the border portion are minimized to make the border portion smooth, in order to determine the border portion of a letter to be printed and correct the jagged edge when the letter is printed.

However, it is required to form a high quality image with further accuracy and at higher speed.

### SUMMARY OF THE INVENTION

The present invention solves or reduces one or more of the above problems.

In an aspect of this disclosure, there is provided an inkjet recording apparatus, including: a recording head configured to include a first nozzle sequence for discharging a black ink and a second nozzle sequence group for discharging a plurality of color inks other than the black ink, in which the first nozzle sequence and the second nozzle sequence group are arranged in a main scan direction; and a jaggy correction process part configured to record a dot for a jaggy correction at a border portion of an image when the image is formed by using the recording head, wherein nozzles forming the first nozzle sequence are displaced by 1/n (n denotes a natural number) in a sub scan direction with respect to nozzles forming the second nozzle sequence group, a record using the black ink is conducted at a first recording position corresponding to the first nozzle sequence, and a record using the plurality of color inks is conducted at a second recording position, and the jaggy correction process part selectively determines a droplet amount of each of the color inks forming the dot for the jaggy correction using the color inks other than the black color, to be less than the droplet amount of the black ink forming the dot for jaggy correction using the black ink.

In an aspect of this disclosure, there is provided an image forming system, including: an inkjet recording apparatus including a recording head configured to include a first nozzle sequence for discharging a black ink and a second nozzle sequence group for discharging a plurality of color inks other than the black ink, in which the first nozzle sequence and the second nozzle sequence group are arranged in a main scan direction, wherein nozzles forming the first nozzle sequence are displaced by 1/n (n denotes a natural number) in a sub scan direction with respect to nozzles forming the second nozzle sequence group; and an information processing apparatus including a jaggy correction process part configured to record a dot for a jaggy correction at a border portion of an image when the image is formed by using the inkjet recording apparatus, wherein the jaggy correction process part selectively determines a droplet amount of each of the color inks forming the dot for the jaggy correction using the color inks other than the black color, to be less than the droplet amount of the black ink forming the dot for jaggy correction using the black ink, and the inkjet recording apparatus conducts a record using the black ink at a first recording position corresponding to the first nozzle sequence and a record using the plurality of color inks at a second recording position, and records the dot for the jaggy correction in accordance with a droplet amount of each of color inks which are selectively set by the jaggy correction process part.

Moreover, the present invention can be realized by a computer program which makes a computer perform as the inkjet recording apparatus and the image forming system and conduct the image forming method. Also, the present invention can be realized by a computer-readable encoding medium recorded with the computer program thereof.

### BRIEF DESCRIPTION OF THE DRAWINGS

In the following, embodiments of the present invention will be described with reference to the accompanying drawings.

FIG. 1 is a perspective diagram illustrating a schematic mechanism of an inkjet recording apparatus according to a first embodiment of the present invention;

FIG. 2A is a diagram illustrating a schematic configuration of a recording head mounted to the inkjet recording apparatus, and FIG. 2B is a diagram illustrating a state of discharging inks onto a recording sheet from the recording head;

FIG. 3 is a plan view illustrating an arrangement state of nozzle sequences and nozzles;

FIG. 4 is a diagram for explaining an operation example of the recording head in recording an image;

FIG. 5 is a diagram illustrating a print state of an example of a letter in which a jagged edge is visible;

FIG. 6 is a diagram illustrating a state of an example of a dot arrangement in which a printed letter is enlarged;

FIG. 7A through FIG. 7D are diagrams illustrating states of jaggy corrections using a small-sized dot and using a medium-sized dot with the small-sized dot;

FIG. 8 is a diagram illustrating a state of arranging a dot formed by a black ink and a dot formed by a process black in applying the jaggy correction;

FIG. 9 is a diagram for explaining a droplet amount of the black ink and a droplet amount of each of color inks producing the process black in the jaggy correction;

FIG. 10A and FIG. 10B are a diagrams for explaining a droplet amount ratio of the color inks producing the process black;

FIG. 11 is a block diagram illustrating a controller for operating the inkjet recording apparatus;

FIG. 12 is a diagram illustrating an arrangement example of nozzles in a recording head of an inkjet recording apparatus according to a second embodiment of the present invention;

FIG. 13 is a schematic diagram illustrating a droplet amount of an ink which forms a dot for the jaggy correction (part 1);

FIG. 14 is a schematic diagram illustrating a droplet amount of an ink which forms a dot for the jaggy correction (part 2); and

FIG. 15A and FIG. 15B are schematic diagrams for illustrating the droplet amount of each of the color inks which form a dot for the jaggy correction by a mixed color of the color inks.

### DESCRIPTION OF THE PREFERRED EMBODIMENT

In the following, an embodiment of the present invention will be described with reference to the accompanying drawings.

### First Embodiment

An inkjet recording apparatus according to an first embodiment includes a recording head in which a first nozzle sequence for jetting a black ink and a second nozzle sequence group for jetting a plurality of color inks other than black ink are arranged in a main scan direction. A process black is generated by mixing colors. Nozzles forming the first nozzle sequence are displaced by 1/n (n denotes natural number) in a sub scan direction. At a first recording position corresponding to the first nozzle sequence, a recording with the black ink is performed. At a second recording position corresponding to the second nozzle sequence group, a recording with the process black is performed. The inkjet recording apparatus further includes a jaggy correction process part for recording jaggy correction dots at a border portion of an image in each of the recordings with the black ink and the process black. A droplet amount for each of the color inks used for the jaggy correction dots as the process black is determined to be less than a droplet amount of the black ink used for the jaggy correction dots.

The inkjet recording apparatus according to the first embodiment will be described in the followings.

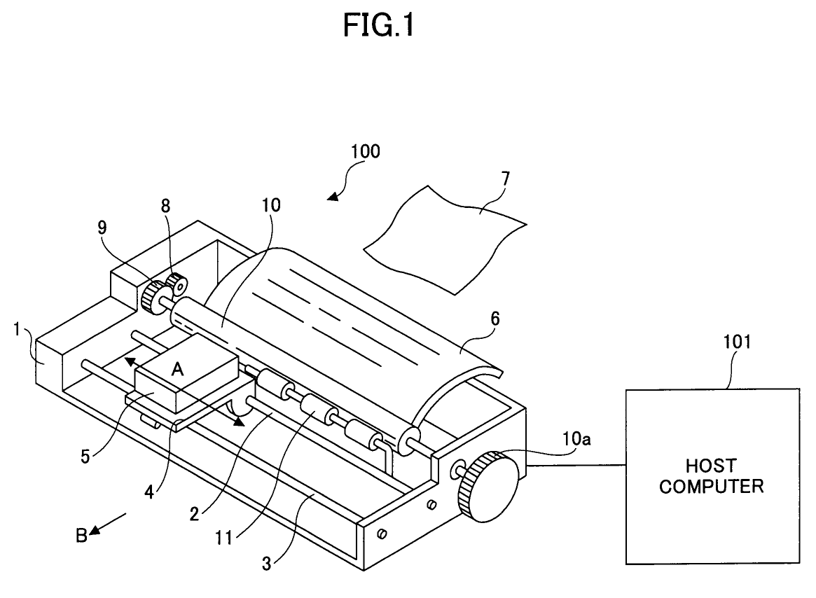

FIG. 1 illustrates a schematic configuration of one of inkjet recording apparatuses. In FIG. 1, an inkjet recording apparatus 100 and a host computer 101 such as a personal computer are illustrated.

Raster data are sent to the inkjet recording apparatus 100 by the host computer 101. A jaggy correction for an image such as a letter is conducted in accordance with a predetermined control program at the host computer 101.

However, the inkjet recording apparatus according to the first embodiment is not limited to this example shown in FIG. 1. Alternatively, the jaggy correction process part can be implemented in the inkjet recording apparatus 100. Also, as described above, the jaggy correction may be implemented in the host computer 101, and a driving signal is sent to the inkjet recording apparatus at a predetermined timing.

The inkjet recording apparatus 100 may receive a predetermined print instruction from application software or a like which is executed in the host computer 101, and may develop to the raster data. In this case, the jaggy correction process part is implemented in the inkjet recording apparatus 100.

The inkjet recording apparatus 100 in this example is a serial type, a carriage 4 is movably mounted to guide rails 2 and 3 bridging a frame 1, and a recording head 5 is equipped with to the recording head 5. The carriage 4 moves in an arrow A direction in FIG. 1 by a predetermined driving source such as a motor (not shown).

A recording sheet 7 is set to a guide board 6, and is caught by a platen 10 which is rotated by a driving gear 8 and a sprocket gear 9. Then, the recording sheet 7 is conveyed in an arrow B direction by a peripheral surface of the platen 10 and a pressure roller 11 clamping the recording sheet 7 with the platen 10.

The platen 10 can be also rotated by using a feeding knob 10a manually.

While moving the recording head 5 (the carriage 4) scanning in the main scan direction (the arrow A direction), the recording sheet 7 is conveyed in the sub scan direction (the arrow B direction), and an ink droplet is jetted from the recording head 5 to print.

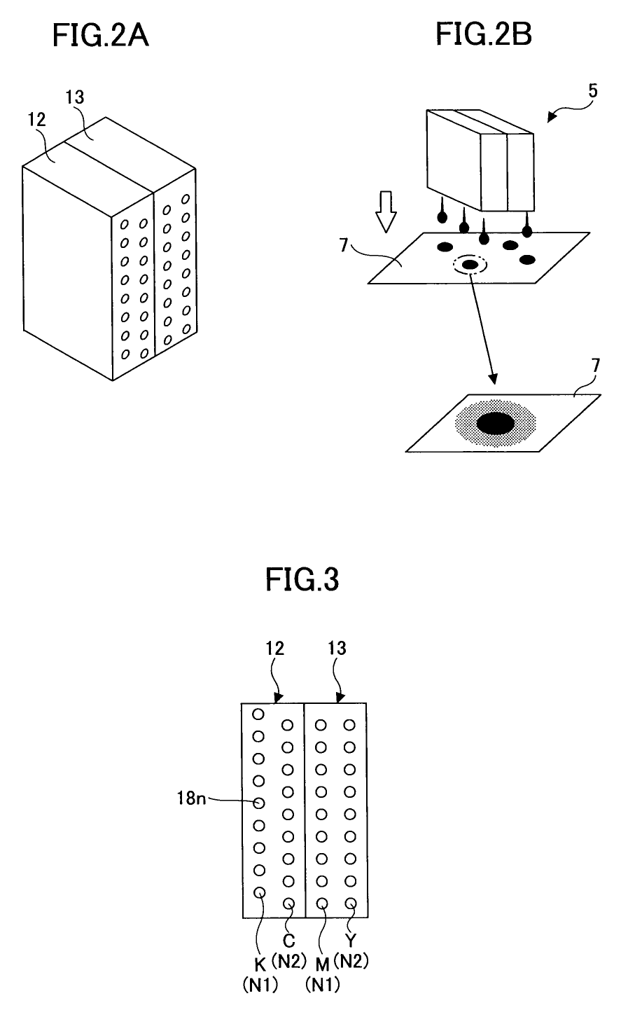

A schematic configuration of the recording head mounted to the inkjet recording apparatus will be described with reference to FIG. 2A and FIG. 2B. FIG. 2A illustrates a configuration of an example of the recording head 5. FIG. 2B illustrates how an ink droplet is recorded onto a recording sheet 7.

The recording head 5 includes spray units 12 and 13 corresponding to color inks. The recording head 5, in which the spray units 12 and 13 are coupled together, and spray ink droplets on a surface of the recording sheet 7.

Each of the spray units 12 and 13 includes a plurality of inkjet nozzles, and sprays inks (pigment inks) being different various sizes of droplets.

The recording head 5 is not limited to the configuration described above. Alternatively, the recording head 5 may include one inkjet head capable of spraying ink droplets of a plurality of colors.

The present invention is not limited to the inkjet recording apparatus 100 for discharging liquid inks for a color print, which is illustrated in this embodiment. Alternatively, as discharge mechanism, a piezometric effect can be used by piezoelectric elements, a film boiling mechanism including a heat generator for generating heat by being conducted, and an electrostatic mechanism, which applies pressure on each ink liquid chamber by displacing a vibration plate with an electrostatic force between the vibration plate and an electrode facing to the vibration plate, can be applied.

FIG. 3 illustrates an elevation view of an example of a nozzle arrangement for the recording head of the inkjet recording apparatus.

In each of the spray units 12 and 13 of the recording head 5, nozzle sequences N1 and N2 are arranged in the main scan direction. Each of the nozzle sequences N1 and N2 includes a plurality of nozzles 18n which align and are arranged on a direction orthogonal to the main scan direction and jet liquid drops.

In FIG. 3, a line (N1) of nozzles K corresponding to the first nozzle sequence for discharging the black ink is displaced by ½ pitch (nozzle pitch) in the sub scan direction with respect to other nozzle sequences corresponding to the second nozzle sequence group.

FIG. 3 illustrates an example in which a nozzle for jetting the black ink is displaced by ½ pitch (nozzle pitch) in the sub scan direction with respect to other nozzles for jetting color inks to generate the process black. However, this displacement is not limited to ½ pitch. Alternatively, for example, 1/n pitch (n denotes natural number equal to or greater than 2) may be set in response to a function of the inkjet recording apparatus 100.

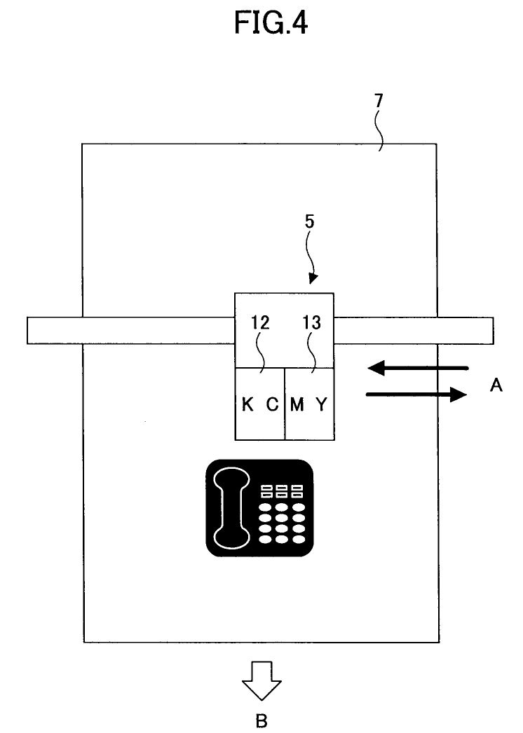

Next, an operation example of the recording head 5 will be described with reference to FIG. 4 in a case of conducting a bi-directional record to the recording sheet 7.

In the recording head 5 shown in FIG. 4, the spray units 12 and 13 are arranged in which nozzle sequences are provided with in an order of black, cyan, magenta, and yellow (hereinafter, simply call K, C, M, and Y).

As shown in FIG. 4, in the inkjet recording apparatus 100, the recording head 5 moves rightward and leftward in the main scan direction (denoted by an arrow A in FIG. 4), and printing is performed by jetting the ink droplets from nozzles in each of a rightward movement and a leftward movement.

An arrangement order of ink colors and the number of the ink colors for the recording head 5 are not limited to this example, and can be appropriately set for a design condition. For example, in response to ink characteristics and various design concepts, an alignment of the nozzles may be selectively set and more various color inks are jetted. For example, inks of R, G, and B (Red, Green, and Black) may be applied, and the black color may be depicted by mixing these colors. Alternatively, in response to a combination of inks mounted to the recording head 5, a function may be included to appropriately select a combination possible to depict the black color from a plurality of patterns. For example, in a case of mounting K (blacK), C (Cyan), M (Magenta), Y (Yellow), R (Red), G (Green), and B (Black) inks, the black color can be depicted by mixing colors: CMY, RGB, RC, GM, BY, and a like.

Also, it is not limited to printing while the recording head 5 moves in each of the rightward movement and the leftward movement. The printing may be performed in either one of the rightward movement and the leftward movement.

Inks for use may be pigment inks or dye inks. Also, the recording head 5 is not limited to a serial head but can be applied to a line head.

A jaggy correction process function in the inkjet recording apparatus according to the present invention will be described in the following. First, a jaggy correction will be described with reference to a detailed example.

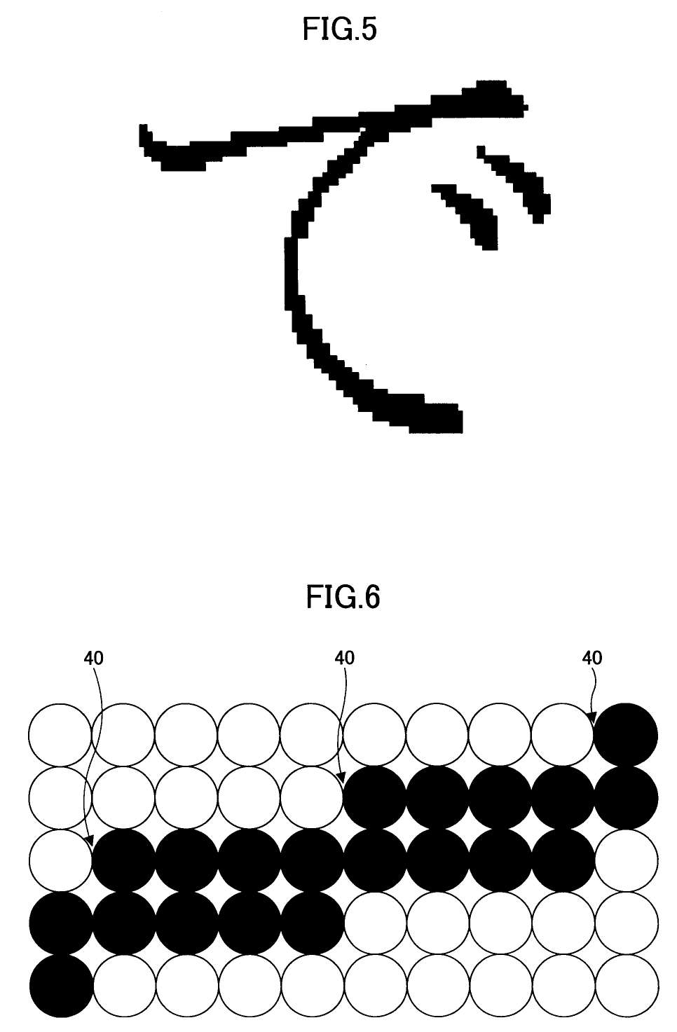

In FIG. 5, the visible jagged edge is shown in a case of printing a Japanese letter “ [symbol] ” (de). FIG. 6 illustrates a dot state arrangement when a hatched portion of the Japanese letter is magnified.

As shown in FIG. 6, a dot line forming a border in the hatched portion of the letter is shaped in a staircase pattern. Thus, at joints (change points 40 in FIG. 6), a border of a line becomes discontinuous, and is recognized as a jagged edge.

In order to perform printing at a high quality, the jaggy correction is required to reduce the jagged edge at the maximum.

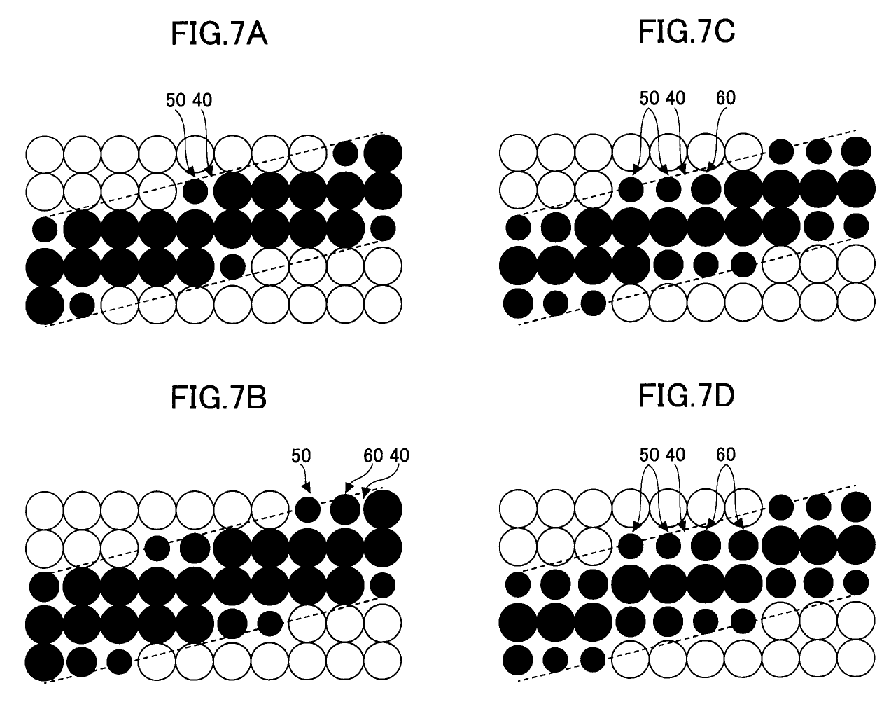

The jaggy correction will be described with reference to FIG. 7A through FIG. 7D. In FIG. 7A through FIG. 7D, the jaggy correction is conducted by additionally applying small-sized dots to blank portions on a letter line formed with large dots (a replacement with the small-sized dots for the blank portions), and/or replacing the large dots in an image portion with the small-sized dots or medium-sized dots.

In detail, FIG. 7A illustrates an example in which a small-sized dot 50 is additionally applied at a change point 40 by the jaggy correction at a blank dot discontinuing the border of the line. FIG. 7B illustrates an example in which a medium-sized dot 60 and the small-sized dot 50 are consecutively added at the change point 40 by the jaggy correction at blank dots discontinuing the border of the line.

FIG. 7C illustrates an example in which a dot in the image portion where the border of the line is discontinuous is replaced with the medium-sized dot 60 and the small-sized dot 50 is successively added twice by the jaggy correction at the change point 40. FIG. 7D illustrates an example in which the medium-sized dot 60 is successively added twice to replace dots in the image portion where the border of the line is discontinuous and the small-sized dot 50 is successively added twice at blank dots by the jaggy correction at the change point 40.

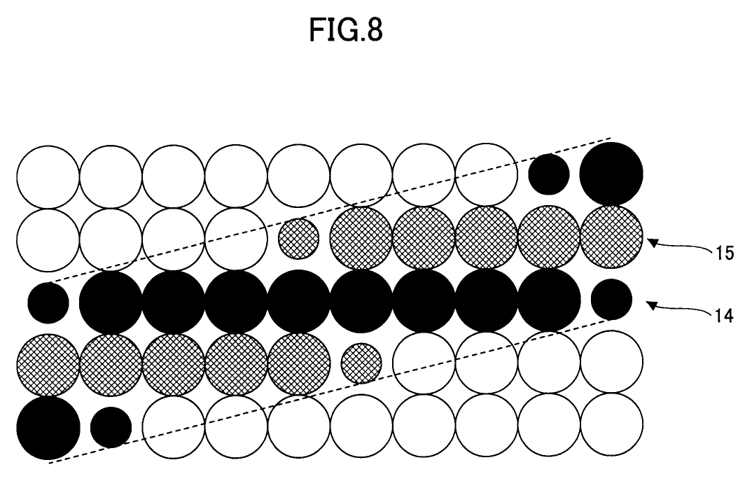

When the jaggy correction is conducted, in a case of applying a state in which the nozzles for discharging the black ink is displaced by ½ pitch (nozzle pitch) in the sub scan direction with respect to the nozzles for discharging the color inks generating the process black (depicted by a mixed color) as the recording head 5 as illustrated in FIG. 3, there are a line 14 recorded by the black ink and a line 15 recorded by the process black as illustrated in FIG. 8. Accordingly, the small-sized dot 50 and the medium-sized dot 60 for jaggy correction are formed in each of lines 14 and 15 by using inks corresponding to lines 14 and 15.

It is not limited to the example illustrated in FIG. 7A through FIG. 7D in which two sizes of the small-sized dot 50 and the medium-sized dot 60 are used as dots for the jaggy correction. Alternatively, desired dots may be formed by adjusting a droplet amount of the ink for the jaggy correction.

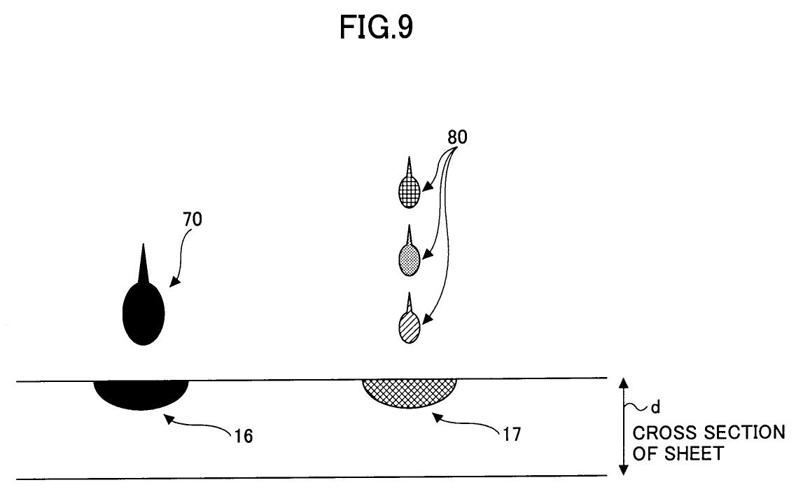

Next, the droplet amount of the ink forming the dot for the jaggy correction will be described with respect to FIG. 9. In FIG. 9, a dot 16 is a dot for the jaggy correction and is formed by a black ink 70. A dot 17 is a dot for the jaggy correction and is formed by each of color inks 80 generating the process black.

A droplet amount of each of the color inks 80 generating the process black is selected to be less than the droplet amount of the black ink 70. If the droplet amount of each of the color inks 80 is greater than that of black ink, the dot 17 formed as the process black becomes larger. As the result, it is difficult to acquire an effect making the jagged edge obscure, and feathering and coloration occur.

Also, as illustrated in FIG. 9, the droplet amount may be selectively determined for each color ink so that a size of the dot 17 for the process black becomes equal to or less than the dot 16 for the black ink. Accordingly, the dot 17 of the process black can be prevented from being larger than the dot 16 of the black ink which is an original black color.

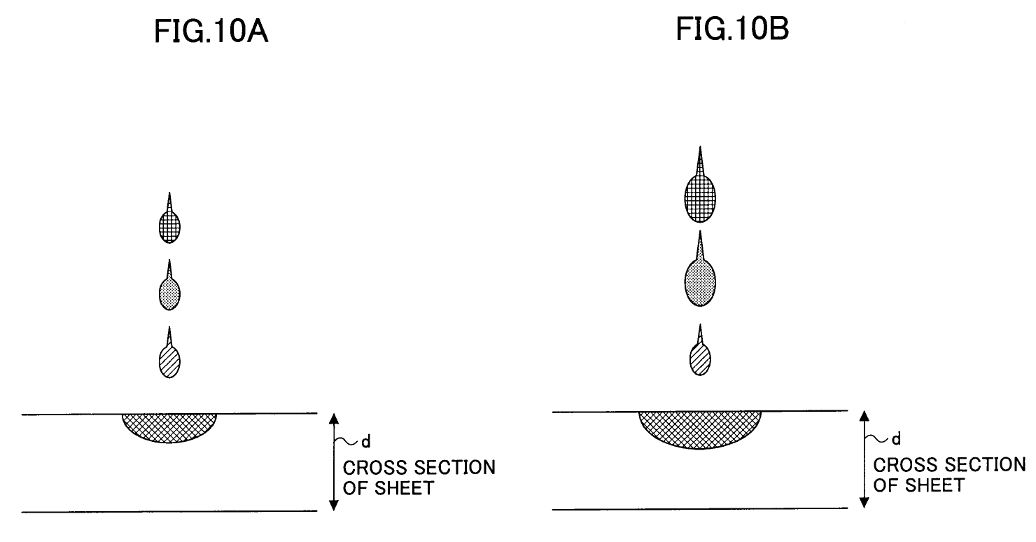

The droplet amount of each of the color inks forming the dot 17 of the process black for the jaggy correction will be described with reference to FIG. 10A and FIG. 10B.

As illustrated in FIG. 10A, the process black may be formed by the same ink droplet amount for all colors. As illustrated in FIG. 10B, the ink droplet amount of at least one color may be adjusted to be different from the ink droplet amounts of other colors. By adjusting the ink droplet amount for each color, it is possible to form the dot 17 of the process black which is nearly perfect to the original black color. By forming the process black as illustrated in FIG. 10A or FIG. 10B, the dot 17 of the process black for the jaggy correction can be a brilliant black color.

It is confirmed that the effect of the jaggy correction as described above is influenced depending on a size of a letter font which is used to print a letter. In detail, compared to an effect of the jaggy correction with respect to a letter of a large font size (approximately 50 pt), an effect of the jaggy correction can be further influenced with respect to a letter of a small font size (approximately 12 pt).

However, in a case in that a font size of a letter to be printed is much smaller (for example, approximately 4 pt), the letter itself may be filled up with dots which are formed by the jaggy correction, and visibility of the letter may be degraded since a line of the letter becomes thicker.

As a result from the above consideration, it is confirmed that a superior effect can be brought out by conducting the jaggy correction process in a case of setting the font size of the letter to be printed as 6 pt to 50 pt. For example, it is possible to suppress a decrease of a recording speed even if the jaggy correction process is conducted for a letter image of a large size which requires time for an image forming process. Also, it is possible to suppress quality deterioration in a case of the letter image of a smaller size.

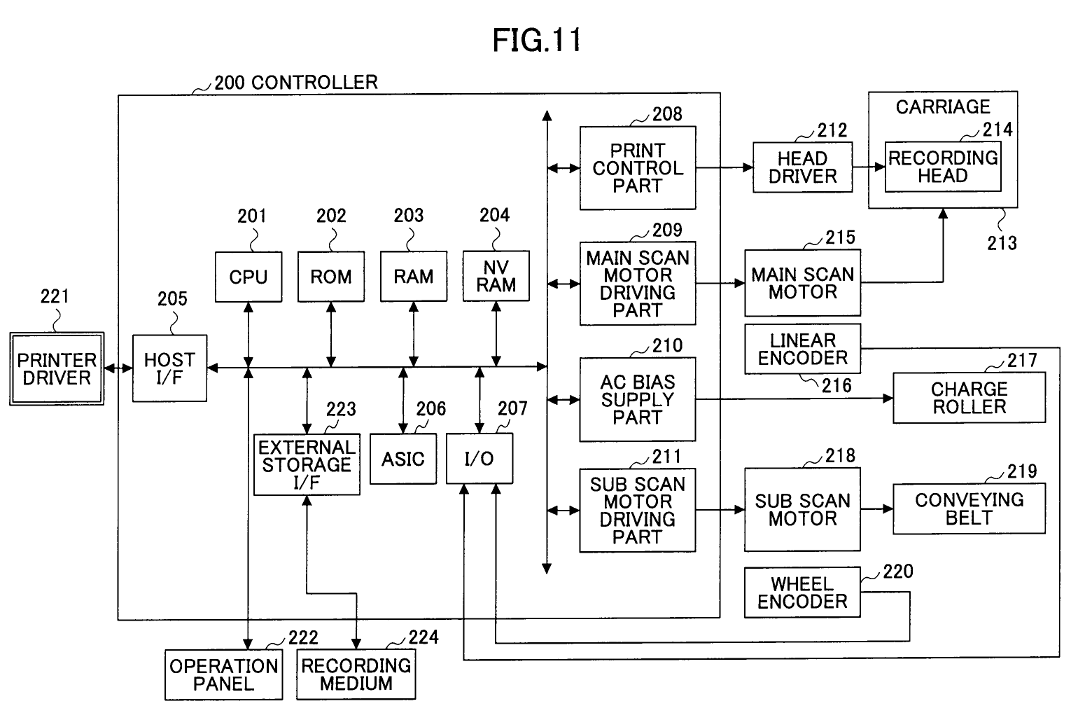

Next, in order for the inkjet recording apparatus 100 according to the present invention to perform printing, a controller 200 driving an internal mechanism will be described with reference to FIG. 11.

The controller 200 illustrated in FIG. 11 includes a CPU (Central Processing Unit) 201 which controls the entire inkjet recording apparatus 100 and includes a part for controlling a conveying operation of a recording sheet and a movement operation of a recording head 214, a ROM (Read Only Memory) 202 which stores programs executed by the CPU 201 and other fixed data, a RAM 203 which temporarily stores image data and a like, a rewritable non-volatile memory 204 which retains data while power is not applied to the inkjet recording apparatus 100, and an ASIC 206 which processes various signals for image data and processes input signals and output signals for controlling an image process for sorting and controlling the entire inkjet recording apparatus 100.

The controller 200 includes a host I/F 205 which sends and receives data and signals to and from a host, a print control part 208 which generates a driving waveform for driving the recording head 214 and outputs the image data for selectively driving a pressure generation part of the recording head 214 and various data accompanying therewith to a head driver 212, a main scan motor driving part 209 which drives a main scan motor 215, a sub scan motor driving part 211 which drives a sub scan motor 218, an AC bias supply part 210 which supplies an AC bias to a sub scan motor 217, an I/O 207 which inputs detection pulses from a linear encoder 216 and a wheel encoder 220 and inputs detection pulses from other various sensors, and a like.

The controller 200 is connected to an operation panel 222 which inputs and displays information necessary for the inkjet recording apparatus 100.

The controller 200 receives print data, which are generated by a printer driver 221 at the host which is an information processing apparatus such as a personal computer or a like, an image reading apparatus such as an image scanner or a like, or an imaging apparatus such as a digital camera or a like, through the host I/F 205 via a cable or a wireless network.

The CPU 201 of the controller 200 reads out and analyses print data in a receive buffer included in the host I/F 205, transfers the print data for which an image process and a sorting process is conducted by the ASIC 206, and outputs the image data and the driving waveform to the head driver 212 from the print control part 208 at a required timing.

The controller 200 further includes an external storage I/F 223 and conducts a data communication with a recording medium 224 (for example, such as a CD-ROM (Compact Disk Read Only Memory), a DVD (Digital Versatile Disk), a flash memory, and a like) which is connected through a data transmission channel such as a USB (Universal Serial Bus). Also, in a case of using a SD (Secure Digital) card as the recording medium 224, the external storage I/F 223 is used as a SD card slot, and data stored in the SD card can be read out and written in by inserting the SD card to the SD card slot.

For example, font data may be stored in the ROM 202, and dot pattern data may be generated to output an image. Alternatively, the image data may be developed to bitmap data at the printer driver 221 at the host, and may be transferred to the controller 200.

The print control part 208 includes a driving waveform generation part including a D/A converter and an amplifier for conducting a D/A conversion for pattern data of the driving pulse which is stored in the ROM 202 and read out by the CPU 201. The driving waveform generation part outputs the driving waveform which is formed by one driving pulse or a plurality driving pulses, to the head driver 212.

The head driver 212 drives the recording head 214 by selectively applying the driving waveform output from the driving waveform generation part of the print control part 208 to a pressure generation part of the recording head 214 based on the image data (dot pattern data) corresponding to one line of the recording head 214 being input serially.

For example, the head driver 212 includes a shift register which inputs a clock signal and serial data being the image data, a latch circuit which latches a register value of the shift register by a latch signal, a level conversion circuit (level shifter) which changes a level of an output value of the latch circuit, and an analogue switch array (switching part) which controls on and off by the level shifter, and a like. The head driver 212 selectively applies a desired driving pulse included in the driving waveform to the pressure generation part of the recording head 214 by controlling on and off of the analogue switch array.

As a practical function of the inkjet recording apparatus 100 operating in accordance with an instruction signal from the controller 200 described above, it is desired to transmit at high speed and digitalize an original image of a high resolution, and to output (print) the original image without reducing the high resolution.

In this embodiment, in order to satisfy both a high speed output and a high resolution output, the original image of the high resolution is converted into an image of a rough resolution by compressing data such as an image to be processed at a controlling part of a computer or a like, and is transmitted to a printer at high speed.

For example, if a resolution of an image to be recorded is higher and a gradient of the image is a high order, a capacity of an input image is a large amount. Thus, it consumes time not only to transmit the image to the inkjet recording apparatus 100 but also to process the image to record at both the hose and the inkjet recording apparatus 100.

Accordingly, for example, every four pixels, which are 2×2 pixels in the input image, are processed as one pixel, and an information amount of the input image is reduced to be ¼ the information amount, so as to make a process time shorter.

On the other hand, the printer conducts a simple image reproduction method with a predetermined mask, so as to acquire the high speed transmission and the high resolution.

Also, if a process performance of the printer is high, an image conversion from a high resolution to a lower resolution may be conducted at the printer.

According to the first embodiment, it is possible to acquire the high quality image in which jagged edges are invisible, even if an image formation is conducted for a subject having many hatched portions. Also, dots for the jaggy correction are formed at both a recording location corresponding to the nozzle sequence for jetting the black ink and a recording location corresponding to the color ink sequences forming the process black. Thus, it is possible to obtain an accurate jaggy correction.

### Second Embodiment

In an inkjet recording apparatus according to a second embodiment, a configuration of nozzles of a recording head is different from the inkjet recording apparatus 100 according to the first embodiment.

In the second embodiment, an inkjet recording system improving a record quality of a letter image is provided in a head configuration in that a process black is not produced since three primary colors (Cyan, Magenta, and Yellow) are not overlaid on the same position at one scan in recording monochrome data using technology which visually improves a resolution by modifying an arrangement of the nozzles.

In an example illustrated below, referring to FIG. 1, raster data are sent from a host computer 101 to the inkjet recording apparatus 100, the jaggy correction with respect to the letter image is conducted at the host computer 101. That is, a part for conducting the jaggy correction process is provided with at the host computer. Alternatively, the part for conducting the jaggy correction part may be provided with at the inkjet recording apparatus 100.

Also, at the inkjet recording apparatus 100, it can be configured to receive a print instruction from application software or a like which is executed at the host computer 101 and develop it to the raster data. In this case, the part for conducting the jaggy correction process is implemented at the inkjet recording apparatus 100.

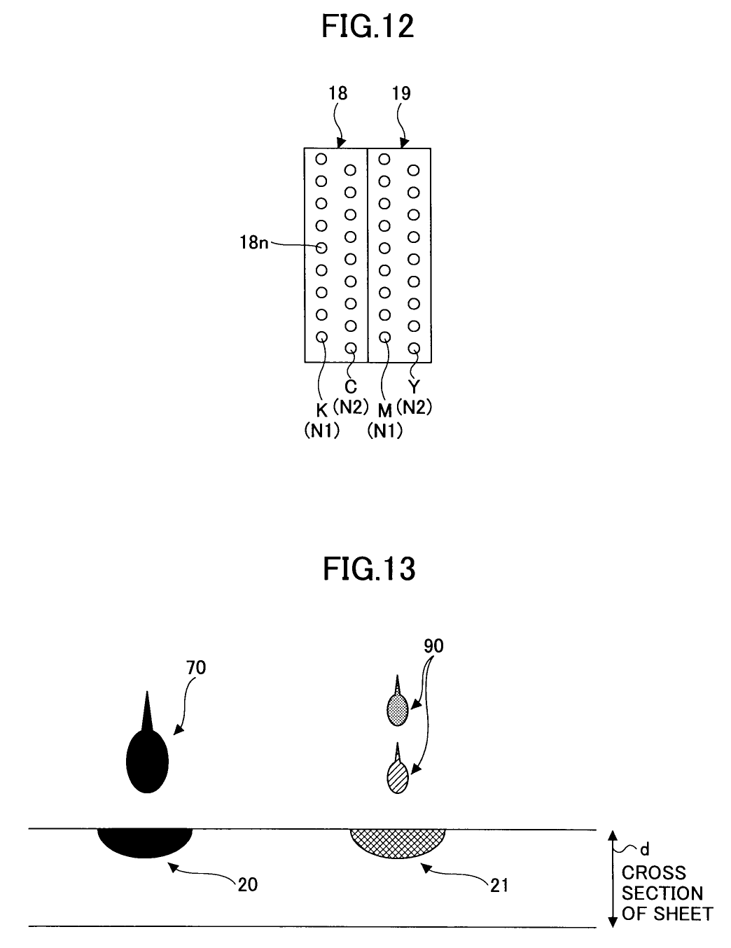

FIG. 12 is a diagram illustrating an arrangement example of the nozzles in the recording head of the inkjet recording apparatus according to the second embodiment. As illustrated in FIG. 12, each of spray units 18 and 19 of the recording head includes nozzle sequences N1 and N2 which are arranged in the main scan direction. Each of the nozzle sequences N1 and N2 includes a plurality of nozzles 18n which align and arrange on a direction orthogonal to the main scan direction and jet liquid drops.

With respect to a nozzle line K (N2) for discharging the black ink, a nozzle line Y (N2) is arranged on one line directed to the main scan direction. Moreover, with respect to the nozzle sequence K(N2), a nozzle sequence C (N1) for discharging a cyan ink and a nozzle sequence M (N1) for discharging a magenta ink are arranged at a location being displaced by ½ pitch (nozzle pitch) between the nozzles 18n.

However, FIG. 12 illustrates a configuration example in that the nozzles K (N1) and M (N1) for discharging the black ink and the yellow ink are displaced by ½ pitch (nozzle pitch) in the sub scan direction from the nozzles C (N2) and Y (N2) for discharging the cyan ink and the magenta ink. It is not limited to this displacement amount in this configuration example. For example, the displacement amount may be 1/n pitch (n denotes natural number equal to or more than 2) due to a design concept and a like.

In FIG. 12, the cyan ink and the magenta ink are aligned at the same pitch, since in a case of mixing two colors from the cyan ink, the magenta ink, and the yellow ink, a combination of the cyan ink and the magenta ink creates a deep color. Accordingly, it is possible to make the deep color much closer to a color recorded by the nozzle sequence K (N1) for the black ink. It is possible to improve visibility more than forming a letter by other combinations.

In a case of conducting a record at one scan by using a head in which the nozzles K (N1) and Y (N1) for the black ink and the yellow ink are displaced to each other at ½ pitch (nozzle pitch) in the sub scan direction and the nozzles C (N2) and M (N2) for the cyan and the magenta are displaced to each other at ½ pitch (nozzle pitch) in the sub scan direction, referring to FIG. 8, there are the line 14 corresponding to the black ink and the yellow ink and the line 15 corresponding to the cyan ink and the magenta ink.

Moreover, regarding dots for the jaggy correction on each line, the line 14 is recorded by a simple color of the black ink or a mixed color created by the black ink and the yellow ink, and the line 15 is recorded by a simple color of the cyan ink or the magenta ink or a mixed color created by the cyan ink and the magenta ink.

By configuring dots for reducing jagged edges with a simple black color of the black ink, a simple color of each color ink, a mixed color of combining the black ink and one or more color inks, or a mixed color of combining a plurality of color inks, it is possible to record dots for reducing the jagged edges at a position where each nozzle can record at one scan. Moreover, it is possible to set a nozzle as an unused nozzle when the nozzle becomes impossible to record due to a defect of discharging an ink or a like, and to continue recording.

FIG. 13 is a schematic diagram illustrating a droplet amount of an ink which forms a dot for the jaggy correction (part 1). As illustrated in FIG. 13, a dot 20 is a dot for the jaggy correction with the black ink 70, and a dot 21 is a dot for the jaggy correction with color inks 90 which are discharged from nozzles being displaced by ½ nozzle pitch with respect to the nozzle discharging the black ink 70.

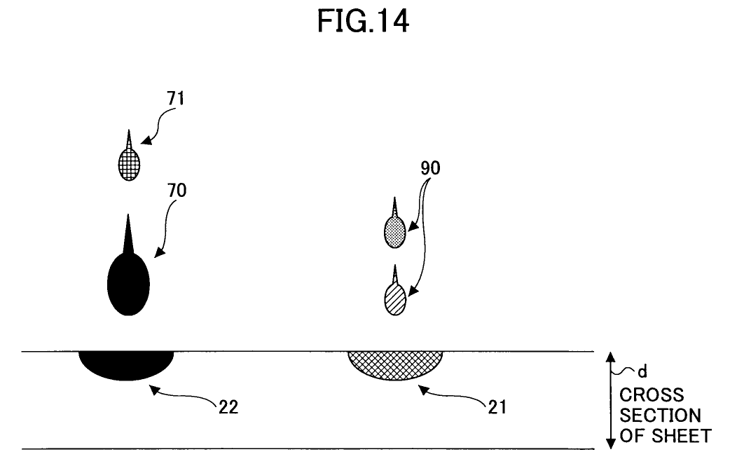

FIG. 14 is a schematic diagram illustrating the droplet amount of the ink which forms the dot for the jaggy correction (part 2). As illustrated in FIG. 14, a dot 22 is a dot for the jaggy correction with the black ink 70 and the yellow ink 71.

In this case, the droplet amount of each color ink is less than the droplet amount of the black ink. Accordingly, it is possible to prevent a highly visible dot being formed by mixing color inks. It is preferable to make a dot 21 formed by a mixed color of the color inks smaller than the dot 20 formed by the black ink in FIG. 13 or a dot 22 including the black ink.

Accordingly, it is possible to prevent the dot 21, generated as a result from reducing the droplet amount of each color ink less than the droplet amount of the black ink, from being greater than the dot 22, and it is also possible to prevent the jagged edge from being visible. In addition, it is possible to prevent an occurrence of exudation.

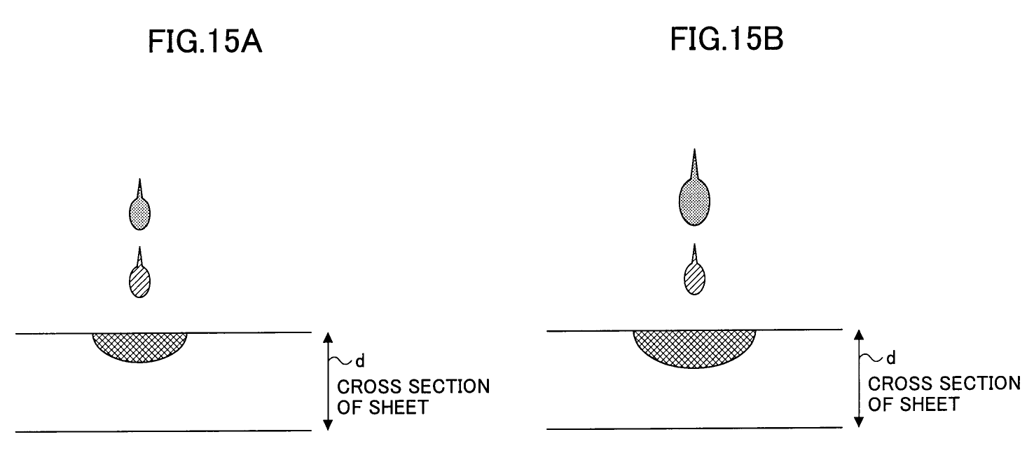

FIG. 15A and FIG. 15B are schematic diagrams for illustrating the droplet amount of each of the color inks which form a dot for the jaggy correction by a mixed color of the color inks. As illustrated in FIG. 15A, the dot is formed by the same droplet amount of each of color inks. Alternatively, as illustrated in FIG. 15B, the droplet amount of at least one of color inks is smaller than the droplet amount of other color inks. It is possible to form the dot having a preferable gray balance by adjusting the droplet amount of each of the color inks.

On the other hand, in a case of applying the jaggy correction to a letter, an effect of the jaggy correction depends on a size of a letter font. For example, the effect of the jaggy correction for a letter of a big size font (approximately 50 pt) is greater than the effect of the jaggy correction for a letter of a small size font (approximately 12 pt). However, if a font size is considerably small (approximately 4 pt), the dot for the jaggy correction is an excessive dot and increases the number of dots. Thus, the letter is filled up with dots and becomes thicker. As a result, the visibility is degraded.

Considering a process time and a like, it is effective to apply the jaggy correction process only for a letter of an approximately font size 6-50 pt. In detail, it is possible to suppress a deterioration of the recording speed in the jaggy correction process conducted for a large letter image which requires time to process, and to suppress degrading a quality of a small letter image due to the dot for the jaggy correction.

There is a case in that exudation occurs at a border portion by applying the jaggy correction and influences an image. Thus, if the jaggy correction does not meet a preference of a user, the user may be set the jaggy correction to be valid or invalid. Thus, the jaggy correction is applied or is not applied based on the setting of the preference of the user. It should be noted that the jaggy correction in the first embodiment can be set to be valid or invalid in the same manner.

Moreover, it is preferable to transmit an original image being a high resolution and to print out without deteriorating the high resolution of the original image. Similar to the first embodiment, in the second embodiment, it is possible to transmit image data to a printer at high speed by compressing the image data by a control part of a computer or a like and converting the original image being the high resolution to a rough image.

For example, if an image to record is a high resolution and the number of gradations of the image is a high order, a capacity of an input image becomes larger. Thus, it consumes time not only to transmit the image to the inkjet recording apparatus 100 but also to process the image to record at both the hose and the inkjet recording apparatus 100. Accordingly, for example, every four pixels, which are 2×2 pixels in the input image, are processed as one pixel, and an information amount of the input image is reduced to be ¼ the information amount, so as to make a process time shorter.

On the other hand, the printer conducts a simple image reproduction method with a predetermined mask, so as to acquire the high speed transmission and the high resolution. Also, if a process performance of the printer is high, an image conversion from a high resolution to a lower resolution may be conducted at the printer.

Moreover, regarding the inkjet recording apparatus according to the second embodiment, in a case of forming a high resolution image, a high speed mode and a high quality image mode can be selectively set. The high speed mode is selected to convert a high resolution to a low resolution if the recording speed is considered more, and the high quality image mode is selected to form an image (2 path image) by having the recording head scan twice.

In this case, when the high speed mode is selected, as described above, every four pixels, which are 2×2 pixels in the input image, are processed as one pixel, and an information amount of the input image is reduced, so as to form an image by one scan of the recording head. On the other hand, when the high quality image mode is selected, it is suppressed to convert into the low resolution.

As described above, according to the second embodiment, in a head configuration in which the process black is not formed by one scan even if the color inks corresponding to a recording position different from the black ink are mixed, it is possible to record an image of a preferably high quality in which a jagged edge easily occurred at the hatched portion of a letter is not visible.

### [Variation]

The inkjet recording apparatus according to the present invention is not limited to the above-described configurations. Alternatively, well-known configurations may be appropriately combined. For example, the jaggy correction function according to the present invention may be implemented at the host computer 101, and a signal is transmitted in response to a request to be executed.

Moreover, a program conducting the jaggy correction described above may be stored at the host computer 101. Alternatively, an execution program may be recorded in a predetermined recording medium, and may be appropriately read out and executed by the host computer 101. The program includes a printer driver which can be built in the host computer 101.

Examples of a recording medium recording the program and data for an image formation using the jaggy correction will be described. As the recording medium, a CD-ROM, a magnetic optical disk, a DVD-ROM (Digital Versatile Disk Read Only Memory), a floppy disk, a flash memory, a memory card, and various ROMs (Read Only Memories) and RAMs (Random Access Memories) can be used. Steps in the first and second embodiments of the present invention described above are made to be executed by a CPU (Computer Processing Unit) of the host computer 101. The program for realizing the above-described image forming method is recorded to the recording medium and distributed in market, so as to easily realize the function.

Thus, the recording medium is set to an information processing apparatus such as a computer and the program is read out from the recording medium. Alternatively, the program is recorded to the recording medium being set to the information process apparatus beforehand, and appropriately read out to perform the image formation.

According to the present invention, it is possible to provide an inkjet recording apparatus which improves a record quality of an image such as a letter in recording a monochrome data.

Moreover, according to the present invention, in a case of conducting an image formation for a subject image having many hatched portions, it is possible to acquire a high quality image in which jagged edges are not visible. Moreover, it is possible to obtain an effect of an accurate jaggy correction by forming the dot for the jaggy correction at each of the recording position corresponding to the nozzle sequence for discharging the black ink and the recording position corresponding to the color ink sequences producing the process black. Furthermore, it is possible to effectively reduce influences of the exudation, a feathering, and a like due to the dot for the jaggy correction using the process black.

The present invention is not limited to the specifically disclosed embodiments, and variations and modifications may be made without departing from the scope of the invention.

The present application is based on the Japanese Priority Patent Applications No. 2007-337176 filed Dec. 27, 2007 and No. 2008-269811 filed Oct. 20, 2008, the entire contents of which are hereby incorporated by reference.

What is claimed is:

1. An inkjet recording apparatus, comprising:
a recording head configured to include a first nozzle sequence for discharging a black ink and a second nozzle sequence group for discharging a plurality of color inks other than the black ink, in which the first nozzle sequence and the second nozzle sequence group are arranged in a main scan direction; and
a jaggy correction process part configured to record a dot for a jaggy correction at a border portion of an image when the image is formed by using the recording head,
wherein nozzles forming the first nozzle sequence are displaced by 1/n (n denotes a natural number) in a sub scan direction with respect to nozzles forming the second nozzle sequence group,
a record using the black ink is conducted at a first recording position corresponding to the first nozzle sequence, and a record using the plurality of color inks is conducted at a second recording position, and
the jaggy correction process part selectively determines a droplet amount of each of the color inks forming the dot for the jaggy correction using the color inks other than the black color, to be less than the droplet amount of the black ink forming the dot for jaggy correction using the black ink.

2. The inkjet recording apparatus as claimed in claim 1, wherein the jaggy correction process part makes a size of the dot for jaggy correction conducting at the first recording position be greater than the dot for jaggy correction conducting at the second recording position.

3. The inkjet recording apparatus as claimed in claim 2, wherein the second nozzle sequence group includes each of nozzle lines for discharging color inks which are to produce a process black by a mixed color and exclude the black ink.

4. The inkjet recording apparatus as claimed in claim 3, wherein the droplet amount of each of the color inks forming the dot for the jaggy correction using the process black is approximately equal to the droplet amounts of other colors.

5. The inkjet recording apparatus as claimed in claim 3, wherein the droplet amount of at least one of the color inks forming the dot for the jaggy correction using the process black is different from the droplet amounts of other color inks.

6. The inkjet recording apparatus as claimed in claim 3, wherein the jaggy correction process part selects a letter image within a predetermined range of a font size as a subject to conduct the jaggy correction.

7. The inkjet recording apparatus as claimed in claim 1, further comprising a first nozzle sequence group configured to include a nozzle sequence, which aligns at the same pitch as the first nozzle sequence in the main scan direction and discharges a color ink other than the black ink, and the first nozzle sequence,
wherein at least the record using the black ink conducts at the first recording position.

8. The inkjet recording apparatus as claimed in claim 7, wherein the dot for the jaggy correction conducted at the first recording position is formed by the black ink alone.

9. The inkjet recording apparatus as claimed in claim 7, wherein the dot for the jaggy correction conducted at the second recording position is formed by any one color of the plurality inks.

10. The inkjet recording apparatus as claimed in claim 7, wherein the droplet amount of each of the color inks forming the dot for the jaggy correction conducted at the second recording position is approximately equal to each other.

11. The inkjet recording apparatus as claimed in claim 7, wherein the droplet amount of each of the color inks forming the dot for the jaggy correction conducted at the second recording position is different from other color inks.

12. The inkjet recording apparatus as claimed in claim 7, wherein the jaggy correction process part selects a letter image within a predetermined range of a font size as a subject to conduct the jaggy correction.

13. The inkjet recording apparatus as claimed in claim 7, further comprising:
a mode selection part configured to selectively set either a high speed mode considering a recording speed or a high quality image mode considering an image quality; and
an image conversion part configured to convert to an image of a lower resolution than a subject image.

14. An image forming system, comprising:
an inkjet recording apparatus including a recording head configured to include a first nozzle sequence for discharging a black ink and a second nozzle sequence group for discharging a plurality of color inks other than the black ink, in which the first nozzle sequence and the second nozzle sequence group are arranged in a main scan direction, wherein nozzles forming the first nozzle sequence are displaced by 1/n (n denotes a natural number) in a sub scan direction with respect to nozzles forming the second nozzle sequence group; and
an information processing apparatus including a jaggy correction process part configured to record a dot for a jaggy correction at a border portion of an image when the image is formed by using the inkjet recording apparatus,
wherein the jaggy correction process part selectively determines a droplet amount of each of the color inks forming the dot for the jaggy correction using the color inks other than the black color, to be less than the droplet amount of the black ink forming the dot for jaggy correction using the black ink, and
the inkjet recording apparatus conducts a record using the black ink at a first recording position corresponding to the first nozzle sequence and a record using the plurality of color inks at a second recording position, and records the dot for the jaggy correction in accordance with a droplet amount of each of color inks which are selectively set by the jaggy correction process part.

15. A computer-readable encoding medium recorded with a computer program, said computer program comprising the codes for:
selectively determining a droplet amount of each of the color inks forming the dot for the jaggy correction using the color inks other than the black color, to be less than the droplet amount of the black ink forming the dot for jaggy correction using the black ink; and
conducting a record using at least the black ink at a first recording position corresponding to the first nozzle sequence and a record using the plurality of color inks is conducted at a second recording position, and recording the dot for the jaggy correction in accordance with the determined droplet amount of each of the color inks.
